(19) United States
(12) Patent Application Publication
(10) Pub. No.: US 2026/0348338 A1
(43) Pub. Date: Nov. 5, 2026

(54) FUEL INJECTION CONTROLLER FOR INTERNAL COMBUSTION ENGINE AND FUEL INJECTION CONTROL METHOD FOR INTERNAL COMBUSTION ENGINE

(71) Applicant: TOYOTA JIDOSHA KABUSHIKI KAISHA, Toyota-shi (JP)

(72) Inventor: Ken YAMAKAWA, Nagoya-shi (JP)

(21) Appl. No.: 19/634,065

(22) Filed: Mar. 31, 2026

(30) Foreign Application Priority Data
Apr. 7, 2025 (JP) 2025-063296

(51) Int. Cl. F02D 41/40; F02D 41/14

(52) U.S. Cl. CPC F02D 41/402; F02D 41/1454; F02D 2200/022

(57) ABSTRACT

A fuel injection controller employs, for a split injection in which fuel is injected into a combustion chamber by being divided into an intake-stroke injection and a compression-stroke injection, an air-fuel ratio feedback correction value, which is a correction value of a fuel injection amount for compensating for a deviation between a target value and a detected value of an air-fuel ratio, by distributing the air-fuel ratio feedback correction value between a fuel injection amount of the intake-stroke injection and a fuel injection amount of the compression-stroke injection, and set a distribution ratio of the air-fuel ratio feedback correction value to the fuel injection amount of the compression-stroke injection to be greater during cold operation of the internal combustion engine than during warm operation of the internal combustion engine.

### CROSS-REFERENCE TO RELATED APPLICATIONS

This application is based upon and claims the benefit of priority from Japanese Patent Application No. 2025-063296, filed on Apr. 7, 2025, the entire contents of which are incorporated herein by reference.

### BACKGROUND

### 1. Field

The present disclosure relates to a fuel injection controller for an internal combustion engine and a fuel injection control method for an internal combustion engine.

### 2. Description of Related Art

Some in-cylinder injection internal combustion engines perform split injection in which fuel is injected in a plurality of split injections. Conventionally, JP2014-173550A discloses that an air-fuel ratio feedback correction value is individually set for each fuel injection of split injection, and the air-fuel ratio feedback correction value is made smaller for a fuel injection whose injection timing is closer to the top dead center of a piston. As the injection timing is closer to the piston top dead center, fuel adhesion to the piston, so-called piston wetting, increases. When the piston wet increases, the amount of particulate matter (PM) generated increases. Therefore, by making the air-fuel ratio feedback correction value smaller for a fuel injection whose injection timing is closer to the piston top dead center, it is possible to suppress an increase in the PM generation amount.

During a cold operation of the internal combustion engine in which the in-cylinder temperature is low, atomization of the injected fuel is poor, and therefore, the proportion of non-contributing fuel that does not contribute to combustion is high. When the air-fuel ratio feedback correction value is distributed to each fuel injection of the split injection during the cold operation as well as during the warm operation, the ratio of the non-contributing fuel may further increase. As a result, deterioration of a combustion state, an increase in fuel consumption, deterioration of emission, and the like may be caused.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An aspect of the present disclosure provides a fuel injection controller for an internal combustion engine configured to perform split injection in which fuel is injected into a combustion chamber by being divided into an intake-stroke injection and a compression-stroke injection. The fuel injection controller includes processing circuitry configured to: employ, for the split injection, an air-fuel ratio feedback correction value by distributing the air-fuel ratio feedback correction value between a fuel injection amount of the intake-stroke injection and a fuel injection amount of the compression-stroke injection, the air-fuel ratio feedback correction value being a correction value of a fuel injection amount for compensating for a deviation between a target value and a detected value of an air-fuel ratio; and set a distribution ratio of the air-fuel ratio feedback correction value to the fuel injection amount of the compression-stroke injection to be greater during cold operation of the internal combustion engine than during warm operation of the internal combustion engine.

An aspect of the present disclosure provides a fuel injection control method for an internal combustion engine. The fuel injection control method includes determining an intake-stroke injection amount that is an injection amount of fuel in an intake stroke and a compression-stroke injection amount that is an injection amount of fuel in a compression stroke immediately after the intake stroke in accordance with the following expressions: QC=SC·Q*+W·LMB; and QI=(1−SC)·Q*+(1−W)·LMB, where QC is the compression-stroke injection amount, QI is the intake-stroke injection amount, a sum of QC and QI is a total amount of fuel to be supplied to a cylinder for one combustion event, Q* is a required injection amount that is a reference amount of the total amount of fuel to be supplied to the cylinder for the one combustion event, SC is a compression-stroke split coefficient having a value in a range of 0 to 1, inclusive, LMB is an air-fuel ratio feedback correction value for correcting the reference amount based on a detected value of an air-fuel ratio obtained by an air-fuel ratio sensor, and W is a weight coefficient having a value in a range of 0 to 1, inclusive. The weight coefficient is: 1 in a range in which an in-cylinder temperature that is a temperature in the cylinder is less than a first temperature; 0 in a range in which the in-cylinder temperature is greater than a second temperature, the second temperature being higher than the first temperature; and a value that decreases from 1 to 0 as the in-cylinder temperature increases in a range in which the in-cylinder temperature is greater than or equal to the first temperature and is less than or equal to the second temperature. The fuel injection control method further includes: injecting the determined intake-stroke injection amount of fuel into the cylinder in the intake stroke; and injecting the determined compression-stroke injection amount of fuel into the cylinder in the compression stroke.

An aspect of the present disclosure provides a fuel injection controller for an internal combustion engine configured to perform split injection in which fuel is injected into a cylinder such that a sum of an intake-stroke injection amount that is an injection amount of fuel in an intake stroke and a compression-stroke injection amount that is an injection amount of fuel in a compression stroke immediately after the intake stroke matches a total amount of fuel to be supplied to the cylinder for one combustion event. The fuel injection controller includes processing circuitry configured to: acquire, for the split injection, an air-fuel ratio feedback correction value that is a correction value of a fuel injection amount for compensating for a deviation between a target value and a detected value of an air-fuel ratio; set the distribution ratio of the air-fuel ratio feedback correction value to the compression-stroke injection amount to be greater during cold operation of the internal combustion engine than during warm operation of the internal combustion engine; and employ the air-fuel ratio feedback correction value by distributing the air-fuel ratio feedback correction value between the intake-stroke injection amount and the compression-stroke injection amount based on the distribution ratio of the air-fuel ratio feedback correction value to the compression-stroke injection amount.

Other features and aspects will be apparent from the following detailed description, the drawings, and the claims.

### BRIEF DESCRIPTION OF THE DRAWINGS

FIG. 1 is a diagram schematically showing a configuration of an embodiment of a fuel injection controller for an internal combustion engine.

FIG. 2 is a flowchart of an injection amount distribution process executed in the fuel injection controller of FIG. 1.

FIG. 3 is a graph showing the relationship between the in-cylinder temperature and the weight coefficient.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

Hereinafter, an embodiment of a fuel injection controller for an internal combustion engine will be described in detail with reference to the drawings.

Configuration of Fuel Injection Controller for Internal Combustion Engine

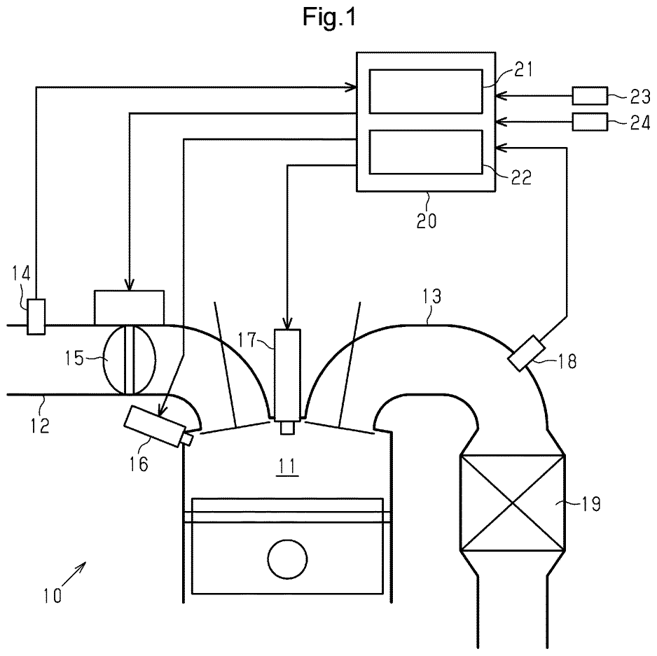

First, a configuration of a fuel injection controller for an internal combustion engine of the present embodiment will be described with reference to FIG. 1. The fuel injection controller of the present embodiment is applied to an internal combustion engine 10 mounted on a vehicle.

As shown in FIG. 1, the internal combustion engine 10 is provided with a combustion chamber 11 for burning fuel. An intake passage 12 that is an introduction path of intake air used for combustion and an exhaust passage 13 that is a discharge path of exhaust gas generated by combustion are connected to the combustion chamber 11. The combustion chamber 11 is a space formed in the cylinder. That is, the combustion chamber 11 is a space surrounded by the cylinder inner wall, the piston, and the cylinder head. The intake passage 12 is provided with an air flow meter 14 that detects an intake air amount GA, which is a flow rate of intake air flowing through the intake passage 12. Further, the intake passage 12 is provided with a throttle valve 15 that adjusts an intake air amount GA by making a flow passage area of intake air variable. The combustion chamber 11 is provided with an in-cylinder injection valve 16 that injects fuel into the combustion chamber 11. Further, the combustion chamber 11 is provided with an ignition device 17 for igniting a mixture of intake air introduced into the combustion chamber 11 through the intake passage 12 and fuel injected by the in-cylinder injection valve 16 by spark discharge. The exhaust passage 13 is provided with an air-fuel ratio sensor 18 for detecting the air-fuel ratio of the air-fuel mixture burned in the combustion chamber 11. An exhaust gas purification device 19 carrying a three way catalyst is provided in the exhaust passage 13.

The internal combustion engine 10 is controlled by an engine control module 20. The ECM 20 includes an arithmetic processing device 21 and a storage device 22. The storage device 22 stores a program and data used for controlling the internal combustion engine 10. The ECM 20 is configured to perform various processes for controlling the internal-combustion engine 10 by the arithmetic processing device 21 executing a program stored in the storage device 22. Detection signals of the air flow meter 14 and the air-fuel ratio sensor 18 are input to the ECM 20. Detection signals of a crank angle sensor 23 and a coolant temperature sensor 24 are also input to the ECM 20. The crank angle sensor 23 is a sensor that detects a crank angle θc that is a rotation angle of a crankshaft that is an output shaft of the internal combustion engine 10. The coolant temperature sensor 24 is a sensor that detects an engine coolant temperature THW, which is the temperature of cooling water of the internal combustion engine 10. The ECM 20 calculates various operation amounts of the internal-combustion engine 10 based on the detection results of these sensors. Examples of the operation amount include a throttle opening degree that is an opening ratio of the throttle valve 15, an ignition timing of an air-fuel mixture by the ignition device 17, and a timing and an amount of fuel injection of the in-cylinder injection valve 16. Then, the ECM 20 controls the internal-combustion engine 10 by operating the throttle valves 15, the in-cylinder injection valves 16, the ignition devices 17, and the like of the internal-combustion engine 10 based on the calculated operation amounts. The ECM 20 calculates an engine rotation speed NE, which is the rotation speed of the crankshaft, based on the detection result of the crank angle θc. Further, the ECM 20 calculates the engine load factor KL based on the engine speed NE, the intake air amount GA and the like. The engine load factor KL represents the intake air filling factor of the combustion chamber 11.

### Outline of Fuel Injection Control

Hereinafter, an outline of fuel injection amount control of the internal combustion engine 10 executed by the ECM 20 will be described. The ECM 20 calculates a total injection amount QT for each calculation cycle of a predetermined fuel injection amount. The total injection amount QT represents a fuel injection amount that the ECM 20 commands the direct injection valve 16 to inject as a required injection amount Q* of fuel. To calculate the total injection amount QT, the ECM 20 uses the engine load factor KL to calculate, as the value of the required injection amount Q*, an amount of fuel required to set the air-fuel ratio of an air-fuel mixture combusted in the combustion chamber 11 to a target value. The required injection amount Q* is a reference amount of the total injection amount QT, which is a total amount of fuel to be supplied to one cylinder for each combustion event. Each combustion event is typically caused by ignition of an air-fuel mixture. The total amount of fuel to be supplied to a cylinder for each combustion event is obtained by correcting the reference amount if necessary. Further, the ECM 20 calculates the value of an air-fuel ratio feedback correction value LMB, which is a correction value of the fuel injection amount, based on the detected value of the air-fuel ratio obtained by the air-fuel ratio sensor 18. The ECM 20 calculates the value of the air-fuel ratio feedback correction value LMB by gradually updating the value so as to reduce the deviation between the detected value and the target value of the air-fuel ratio. Then, the ECM 20 calculates the value of the total injection amount QT by adding the air-fuel ratio feedback correction value LMB to the required injection amount Q* (QT=Q*+LMB). To calculate the total injection amount QT, the ECM 20 performs various corrections in addition to the air-fuel ratio feedback correction value LMB.

The ECM 20 selectively performs split injection in which the fuel to be combusted in the combustion chamber 11 is injected by being split into intake-stroke injection and compression-stroke injection, and non-split injection in which the fuel is injected without being split. The ECM 20 determines which of the split injection and the non-split injection is to be performed based on the engine speed NE, the engine load factor KL, the engine coolant temperature THW, and the like. At the time of non-split injection, the ECM 20 commands the in-cylinder injector 16 to inject the total injection amount QT of fuel from the injection timing determined in accordance with the operating state of the engine 10. On the other hand, at the time of split injection, the ECM 20 divides the total injection amount QT into the intake-stroke injection amount QI and the compression-stroke injection amount QC. The intake-stroke injection amount QI indicates the fuel injection amount of the intake-stroke injection, and the compression-stroke injection amount QC indicates the fuel injection amount of the compression-stroke injection. Then, the ECM 20 commands the in-cylinder injection valves 16 to inject fuel in the intake-stroke injection amount QI during the intake stroke and to inject fuel in the compression-stroke injection amount QC during the compression stroke.

### Injection Amount Distribution Process for Split Injection

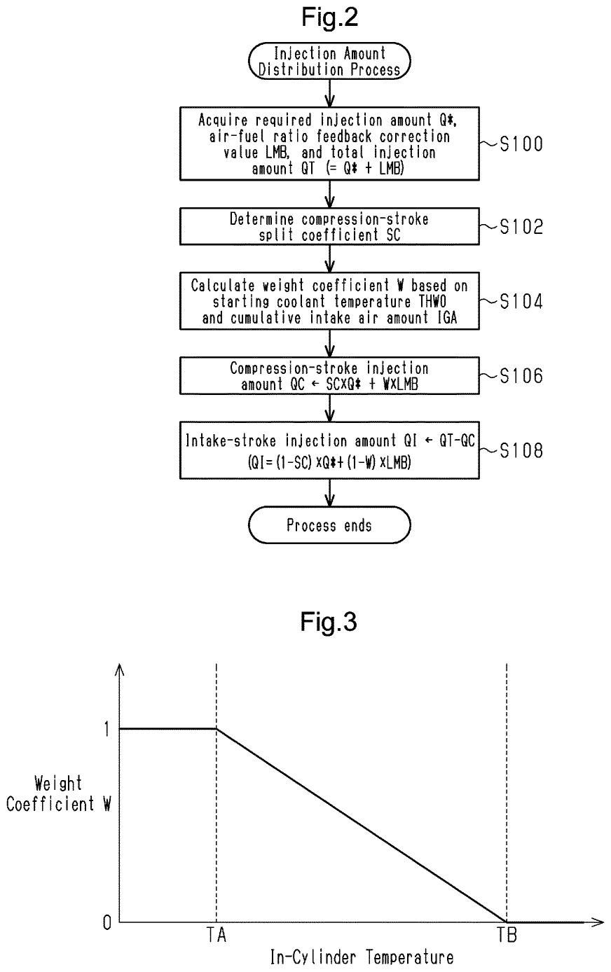

Next, referring to FIGS. 2 and 3, an injection amount distribution process performed by the ECM 20 to calculate the intake-stroke injection amount QI and the compression-stroke injection amount QC at the time of split injection will be described. FIG. 2 shows a flowchart of the injection amount distribution process. In the drawing, the prefix “S” attached to each reference sign represents a step. The ECM 20 repeatedly executes the processing of FIG. 2 for each calculation cycle of the fuel injection amount during execution of the split injection.

When the process of FIG. 2 is started, the ECM 20 first acquires the values of the required injection amount Q*, the air-fuel ratio feedback correction value LMB, and the total injection amount QT in S100. These values are calculated in a process different from this process.

Next, the ECM 20 determines the compression-stroke split coefficient SC in S102. The compression-stroke split coefficient SC represents a ratio of the fuel injected in the compression-stroke injection to the fuel combusted in the combustion chamber 11. The ECM 20 calculates the value of the compression-stroke split coefficient SC based on the operating conditions of the engine 10, for example, the engine speed NE, the engine load factor KL, and the engine coolant temperature THW.

Subsequently, the ECM 20 calculates a weight coefficient W in S104. The weight coefficient W represents a distribution ratio of the air-fuel ratio feedback correction value LMB to the compression-stroke injection amount QC. The weight coefficient W is set to a value from 0 to 1. In this embodiment, the ECM 20 calculates the value of the weight coefficient W based on the starting coolant temperature THW0 and the cumulative intake air amount IGA. The starting coolant temperature THW0 represents the engine coolant temperature THW at the start of the engine 10. The starting coolant temperature THW0 corresponds to the wall surface temperature of the combustion chamber 11 at the start-up of the engine 10. On the other hand, the cumulative intake air amount IGA represents an integrated value of the intake air amount GA after the start of the internal combustion engine 10. Since the cumulative intake air amount IGA corresponds to the integrated value of the amount of heat received by the wall surface of the combustion chamber 11 after the start of the internal combustion engine 10, the amount of rise in the in-cylinder temperature after the start of the internal combustion engine 10 can be estimated from the cumulative intake air amount IGA. Therefore, the current in-cylinder temperature can be estimated from the starting coolant temperature THW0 and the cumulative intake air amount IGA. The ECM 20 determines the value of the weighting coefficient W in accordance with the in-cylinder temperature estimated from the starting coolant temperature THW0 and the cumulative intake air amount IGA.

Next, in S106, the ECM 20 calculates a value that satisfies the relationship of expression (1) as the value of the compression-stroke injection amount QC. The first term on the right side of expression (1) represents a value obtained by multiplying the required injection amount Q* by the compression-stroke split coefficient SC. The second term on the right side of expression (1) represents a value obtained by multiplying the air-fuel ratio feedback correction value LMB by the weight coefficient W. That is, the ECM 20 allocates a portion of the required injection amount Q* having a ratio corresponding to the value of the compression-stroke split coefficient SC and a portion of the air-fuel ratio feedback correction value LMB having a ratio corresponding to the value of the weight coefficient W to the compression-stroke injection amount QC.

QC=SC·Q*+W·LMB Expression (1)

Subsequently, in S108, the ECM 20 calculates the value of the intake-stroke injection amount QI by subtracting the compression-stroke injection amount QC from the total injection amount QT. As described above, the total injection amount QT is calculated as a value obtained by adding the air-fuel ratio feedback correction value LMB to the required injection amount Q*. Therefore, the intake-stroke injection amount QI is a value that satisfies the relationship of expression (2). The first term on the right side of expression (2) is a value obtained by multiplying the required injection amount Q* by a value obtained by subtracting the compression-stroke split coefficient SC from 1 (=1−SC). The second term on the right side of expression (2) is a value obtained by multiplying the air-fuel ratio feedback correction value LMB by a value obtained by subtracting the weight coefficient W from 1 (=1−W). After calculating the intake-stroke injection amount QI, the ECM 20 ends the process of FIG. 2 in the current calculation cycle.

QI=(1−SC)·Q*+(1−W)·LMB Expression (2)

FIG. 3 shows a relationship between the weight coefficient W calculated by the ECM 20 in the S104 of FIG. 2 and the in-cylinder temperature estimated from the starting coolant temperature THW0 and the cumulative intake air amount IGA. The ECM 20 sets “1” as the value of the weight coefficient W when the in-cylinder temperature is lower than a first temperature TA, and sets “0” as the value of the weight coefficient W when the in-cylinder temperature exceeds a second temperature TB higher than the first temperature TA. When the in-cylinder temperature is greater than or equal to the first temperature TA and less than or equal to the second temperature TB, the ECM 20 sets the weighting coefficient W to a value that decreases from a value of “1” when the in-cylinder temperature is the first temperature TA to a value of “0” when the in-cylinder temperature is the second temperature TB as the in-cylinder temperature increases.

In this embodiment, the weight coefficient W corresponds to a distribution ratio of the air-fuel ratio feedback correction value LMB to the compression-stroke injection amount QC. The ECM 20 sets the value of the weighting coefficient W such that the distribution ratio of the air-fuel ratio feedback correction value LMB to the compression-stroke injection amount QC is larger when the in-cylinder temperature is low than when the in-cylinder temperature is high. In other words, the ECM 20 sets the value of the weight coefficient W such that the distribution ratio of the air-fuel ratio feedback correction value LMB to the compression-stroke injection amount QC is larger during the cold operation of the engine 10 than during the warm operation of the engine 10.

### Operation of Embodiment

In the fuel injection controller of the present embodiment, the ECM 20 performs an air-fuel ratio feedback correction of the fuel injection amount based on the deviation between the detected value by the air-fuel ratio sensor 18 and the target value of the air-fuel ratio of the mixture combusted in the combustion chamber 11. Through such an air-fuel ratio feedback correction, the ECM 20 suppresses variations in the fuel injection amount due to individual differences in the fuel injection characteristics of the in-cylinder injection valves 16, changes over time, and the like. At the time of split injection, it is necessary to distribute the air-fuel ratio feedback correction value LMB to one or both of the intake-stroke injection amount QI and the compression-stroke injection amount QC.

In the following description, the ratio of the fuel that does not contribute to combustion to the fuel injected by the in-cylinder injection valve 16 is referred to as a non-contributing fuel ratio. During the cold operation of the internal combustion engine 10 in which the in-cylinder temperature is low, the fuel is difficult to vaporize, and thus the non-contributing fuel ratio is larger than that during the warm operation. When the non-contributing fuel ratio is large, the ratio of the actually combusted fuel to the fuel corresponding to the air-fuel ratio feedback correction value becomes small. Therefore, during the cold operation, the air-fuel ratio feedback correction value LMB required to compensate for the deviation between the required injection amount Q* and the amount of fuel actually burned tends to be larger than that during the warm operation. When the air-fuel ratio feedback correction value LMB increases, the amount of the non-contributing fuel further increases. As a result, an increase in fuel consumption of the internal combustion engine 10, deterioration of emission, and deterioration of drivability due to deterioration of combustion may be caused.

In contrast, in the case of the present embodiment, the ECM 20 changes the distribution ratio of the air-fuel ratio feedback correction values LMB of the intake-stroke injection amount QI and the compression-stroke injection amount QC in accordance with the in-cylinder temperature. To be more specific, the ECM 20 variably sets the distribution ratio based on the in-cylinder temperature of the engine 10 such that the distribution ratio of the air-fuel ratio feedback correction value LMB to the compression-stroke injection amount QC is larger when the in-cylinder temperature is low than when the in-cylinder temperature is high. As a result, the distribution ratio of the air-fuel ratio feedback correction value LMB to the compression-stroke injection amount QC is larger during the cold operation of the internal combustion engine 10 than during the warm operation. Further, the distribution ratio of the air-fuel ratio feedback correction value LMB to the intake-stroke injection amount QI is smaller during the cold operation of the internal combustion engine 10 than during the warm operation thereof.

During the compression stroke, the in-cylinder temperature rises due to compression of intake air. Accordingly, during cold operation, the non-contributing fuel ratio of the compression-stroke injection is smaller than that of the intake-stroke injection. Thus, in the split injection during cold operation in which the in-cylinder temperature is relatively low, an increase in the non-contributing fuel is limited by distributing the air-fuel ratio feedback correction value LMB to the compression-stroke injection having a smaller non-contributing fuel ratio than the intake-stroke injection.

The compression-stroke injection has more restrictions on the injection start/end timing than the intake-stroke injection, and it is difficult to cope with the increase/decrease of the injection period by the air-fuel ratio feedback correction. Further, during the warm operation, since the time until the start of combustion is long and atomization of the injected fuel progresses due to the in-cylinder air flow, the ratio of the non-contributing fuel is suppressed to be small even in the intake-stroke injection. Therefore, during the warm operation, the ECM 20 distributes the air-fuel ratio feedback correction value LMB to the intake-stroke injection, which is more easily adapted to the increase and decrease of the injection period than the compression-stroke injection.

In this embodiment, when the in-cylinder temperature is lower than the first temperature TA, the ECM 20 sets the weighting coefficient W to “1” to distribute all of the air-fuel-ratio feedback correction values LMB to the compression-stroke injection amounts QC. When the in-cylinder temperature exceeds the second temperature TB, the ECM 20 sets the weighting coefficient W to “0” to distribute all of the air-fuel ratio feedback correction values LMB to the intake-stroke injection amounts QI. When the in-cylinder temperature is in the range from the first temperature TA to the second temperature TB, the ECM 20 sets a value that decreases from “1” to “0” in accordance with an increase in the in-cylinder temperature as the value of the weighting coefficient W. Thus, the distribution ratio of the air-fuel ratio feedback correction value LMB to the compression-stroke injection amount QC is decreased from “1” to “0” in accordance with an increase in the in-cylinder temperature from the first temperature TA to the second temperature TB.

### Advantages of Embodiment

The fuel injection controller for the internal combustion engine 10 of the present embodiment has the following effects.
(1) In the split injection of the intake-stroke injection and the compression-stroke injection, the ECM 20 increases the distribution ratio of the air-fuel ratio feedback correction value LMB to the compression-stroke injection amount QC during the cold operation of the engine 10 as compared with the distribution ratio during the warm operation. Thus, an increase in the air-fuel ratio feedback correction value LMB during the cold operation is suppressed. That is, the fuel injection controller can suppress an increase in the amount of fuel that does not contribute to combustion when the split injection of the intake-stroke injection and the compression-stroke injection is performed during the cold operation of the internal combustion engine 10. As a result, it is possible to suppress an increase in fuel consumption of the internal combustion engine 10 due to an increase in non-contributing fuel, deterioration of emissions, and deterioration of drivability due to deterioration of combustion.
(2) The ECM 20 variably sets the distribution ratio of the air-fuel ratio feedback correction value LMB with respect to the intake-stroke injection amount QI and the compression-stroke injection amount QC at the time of split injection based on the in-cylinder temperature of the engine 10. To be more specific, the ECM 20 variably sets the distribution ratio so that the distribution ratio of the air-fuel ratio feedback correction value LMB to the compression-stroke injection amount QC is larger when the in-cylinder temperature is low than when the in-cylinder temperature is high. Therefore, the distribution ratio of the air-fuel ratio feedback correction value LMB to the intake-stroke injection amount QI and the compression-stroke injection amount QC can be appropriately adjusted according to the rise in the in-cylinder temperature.
(3) The ECM 20 estimates the in-cylinder temperature based on the coolant temperature THW0 at the start of the engine 10 and the cumulative intake air amount IGA after the start of the engine 10. Therefore, even if the in-cylinder temperature is not directly detected, the distribution ratio of the air-fuel ratio feedback correction value LMB to the intake-stroke injection amount QI and the compression-stroke injection amount QC can be appropriately adjusted according to the in-cylinder temperature.

### Modifications

The above embodiment may be modified as described below. The above embodiment and the following modifications can be combined as long as the combined modifications remain technically consistent with each other.

The in-cylinder temperature may be estimated in a manner different from the above-described embodiment. For example, the in-cylinder temperature may be estimated on the basis of the engine coolant temperature THW, the outside air temperature, the elapsed time after the start, and the like. Further, the in-cylinder temperature may be directly detected by using a temperature sensor or the like for detecting the cylinder wall surface temperature.

In the case of the above embodiment, when the in-cylinder temperature is lower than the first temperature TA, the distribution ratio of the air-fuel ratio feedback correction value LMB to the intake-stroke injection amount QI is set to “0”. The distribution ratio of the air-fuel ratio feedback correction value LMB to the intake-stroke injection amount QI may be set to a certain value or more regardless of the in-cylinder temperature. Further, when the in-cylinder temperature exceeds the second temperature TB, the distribution ratio of the air-fuel ratio feedback correction value LMB to the compression-stroke injection amount QC is set to “0”. The distribution ratio of the air-fuel ratio feedback correction value LMB to the compression-stroke injection amount QC may be set to a certain value or more regardless of the in-cylinder temperature.

The distribution mode of the air-fuel ratio feedback correction value LMB with respect to the intake-stroke injection amount QI and the compression-stroke injection amount QC in the above embodiment may be changed as appropriate as long as the distribution ratio with respect to the compression-stroke injection amount QC is larger during the cold operation than during the warm operation.

In the above embodiment, the ECM 20 includes a central processing unit (CPU), a random-access memory (RAM), and a read-only memory (ROM). The ECM 20 executes software processing. However, this is merely exemplary. For example, the ECM 20 may include a dedicated hardware circuit that processes at least a part of the software processing executed in the above-described embodiment. The dedicated hardware circuit is, for example, an application-specific integrated circuit (ASIC). That is, the ECM 20 may have any one of the following configurations (a) to (c). (a) The ECM 20 includes a processing device that executes all processes in accordance with a program and a program storage device such as a ROM that stores the program. That is, the ECM 20 includes a software execution apparatus. (b) The ECM 20 includes a processing device that executes a part of processing in accordance with a program, and a program storage device. In addition, the ECM 20 includes dedicated hardware circuitry for performing the remaining processing. (c) The ECM 20 includes a dedicated hardware circuit for executing all processing. There may be multiple software execution devices and/or dedicated hardware circuits. That is, the above-described processes may be executed by processing circuitry that includes at least one of a software execution device and a dedicated hardware circuit. The processing circuitry may include more than one software execution device and more than one dedicated hardware circuit. The program storage device, or computer readable medium, includes any available storage medium that is accessible by a versatile computer or a dedicated computer.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. A fuel injection controller for an internal combustion engine configured to perform split injection in which fuel is injected into a combustion chamber by being divided into an intake-stroke injection and a compression-stroke injection, the fuel injection controller comprising processing circuitry configured to:
employ, for the split injection, an air-fuel ratio feedback correction value by distributing the air-fuel ratio feedback correction value between a fuel injection amount of the intake-stroke injection and a fuel injection amount of the compression-stroke injection, wherein the air-fuel ratio feedback correction value is a correction value of a fuel injection amount for compensating for a deviation between a target value and a detected value of an air-fuel ratio; and
set a distribution ratio of the air-fuel ratio feedback correction value to the fuel injection amount of the compression-stroke injection to be greater during cold operation of the internal combustion engine than during warm operation of the internal combustion engine.

2. The fuel injection controller for the internal combustion engine according to claim 1, wherein
the processing circuitry is configured to set the distribution ratio of the air-fuel ratio feedback correction value to the fuel injection amount of the compression-stroke injection and the distribution ratio of the air-fuel ratio feedback correction value to the fuel injection amount of the intake-stroke injection based on an in-cylinder temperature, such that the distribution ratio of the air-fuel ratio feedback correction value to the fuel injection amount of the compression-stroke injection is larger when the in-cylinder temperature is relatively low than when the in-cylinder temperature is relatively high.

3. The fuel injection controller for the internal combustion engine according to claim 2, wherein
the processing circuitry is configured to estimate the in-cylinder temperature based on a starting coolant temperature of the internal combustion engine and a cumulative intake air amount that is obtained after starting the internal combustion engine.

4. The fuel injection controller for the internal combustion engine according to claim 1, wherein
the processing circuitry is configured to set a value of the distribution ratio of the air-fuel ratio feedback correction value to the compression-stroke injection to:
1 when an in-cylinder temperature is less than a first temperature;
0 when the in-cylinder temperature is greater than a second temperature,
the second temperature being higher than the first temperature; and
in a case in which the in-cylinder temperature is greater than or equal to the first temperature and less than or equal to the second temperature, a value that decreases in accordance with an increase in the in-cylinder temperature from a value of 1 when the in-cylinder temperature is the first temperature to a value of 0 when the in-cylinder temperature is the second temperature.

5. A fuel injection control method for an internal combustion engine, comprising determining an intake-stroke injection amount that is an injection amount of fuel in an intake stroke and a compression-stroke injection amount that is an injection amount of fuel in a compression stroke immediately after the intake stroke in accordance with the following expressions:
QC=SC·Q*+W·LMB; and
QI=(1−SC)·Q*+(1−W)·LMB,
where QC is the compression-stroke injection amount, QI is the intake-stroke injection amount, a sum of QC and QI is a total amount of fuel to be supplied to a cylinder for one combustion event, Q* is a required injection amount that is a reference amount of the total amount of fuel to be supplied to the cylinder for the one combustion event, SC is a compression-stroke split coefficient having a value in a range of 0 to 1, inclusive, LMB is an air-fuel ratio feedback correction value for correcting the reference amount based on a detected value of an air-fuel ratio obtained by an air-fuel ratio sensor, and W is a weight coefficient having a value in a range of 0 to 1, inclusive, wherein
the weight coefficient is:
1 in a range in which an in-cylinder temperature that is a temperature in the cylinder is less than a first temperature;
0 in a range in which the in-cylinder temperature is greater than a second temperature, the second temperature being higher than the first temperature; and
a value that decreases from 1 to 0 as the in-cylinder temperature increases in a range in which the in-cylinder temperature is greater than or equal to the first temperature and is less than or equal to the second temperature, and
the fuel injection control method further comprises:
injecting the determined intake-stroke injection amount of fuel into the cylinder in the intake stroke; and
injecting the determined compression-stroke injection amount of fuel into the cylinder in the compression stroke.

6. A fuel injection controller for an internal combustion engine configured to perform split injection in which fuel is injected into a cylinder such that a sum of an intake-stroke injection amount that is an injection amount of fuel in an intake stroke and a compression-stroke injection amount that is an injection amount of fuel in a compression stroke immediately after the intake stroke matches a total amount of fuel to be supplied to the cylinder for one combustion event, the fuel injection controller comprising processing circuitry configured to:
acquire, for the split injection, an air-fuel ratio feedback correction value that is a correction value of a fuel injection amount for compensating for a deviation between a target value and a detected value of an air-fuel ratio;
set the distribution ratio of the air-fuel ratio feedback correction value to the compression-stroke injection amount to be greater during cold operation of the internal combustion engine than during warm operation of the internal combustion engine; and
employ the air-fuel ratio feedback correction value by distributing the air-fuel ratio feedback correction value between the intake-stroke injection amount and the compression-stroke injection amount based on the distribution ratio of the air-fuel ratio feedback correction value to the compression-stroke injection amount.

7. The fuel injection controller for the internal combustion engine according to claim 6, wherein
the distribution ratio of the air-fuel ratio feedback correction value to the compression-stroke injection amount increases as an in-cylinder temperature that is a temperature in the cylinder decreases.
